(19) United States
(12) Patent Application Publication
(10) Pub. No.: US 2025/0194693 A1
(43) Pub. Date: Jun. 19, 2025

(54) KEY STRUCTURE AND AN ELECTRONIC ATOMIZER HOST

(71) Applicant: Shenzhen Impetus Technology Co., Ltd., Shenzhen (CN)

(72) Inventor: Liqian Chen, Shenzhen (CN)

(21) Appl. No.: 18/410,453

(22) Filed: Jan. 11, 2024

(30) Foreign Application Priority Data
Dec. 14, 2023 (CN) 2023234122285

(51) Int. Cl. A24F 40/60; A24F 40/40; H01H 13/04; H01H 13/14

(52) U.S. Cl. CPC A24F 40/60; A24F 40/40; H01H 13/04; H01H 13/14

(57) ABSTRACT

A key structure and an electronic atomizer host comprises a housing with an assembly cavity, and a through-hole connected to the assembly cavity; a mainboard is arranged in the assembly cavity, a button is arranged on the mainboard; a key is arranged in the assembly cavity and corresponds to the button, the key can move towards the direction close to the button, and one side of the key away from the button is located in the through-hole without protruding out of the through-hole; and a sleeve, which is fitted onto the housing, and the sleeve is provided with an identification structure corresponding to the position of the through-hole, the sleeve can deform when subjected to pressure. It can be seen that the key structure in this invention has good integrity, a comfortable grip, and can enhance the user's experience of use.

### 1. TECHNICAL FIELD

The invention relates to the technical field of electronic atomizers, in particular to a key structure and an electronic atomizer host.

### 2. BACKGROUND ART

An electronic atomizer is an electronic device that heats e-liquid to generate smoke, which is then inhaled by the user to simulate a cigarette. Generally, an electronic atomizer consists of two main parts: the host and the atomizer. The atomizer can be installed on the host in a detachable manner. The host supplies power to the atomizer and controls its operation to produce smoke. However, currently, the buttons on the host are typically protruding and exposed on the housing, resulting in poor overall integration of the host and an unsatisfactory grip.

### 3. SUMMARY OF THE INVENTION

The invention provides a key structure and an electronic atomizer host to solve the technical problems mentioned in the above background art.

The technical scheme adopted by the invention is a key structure, comprising:
A housing with an assembly cavity, and a through-hole connected to the assembly cavity;
A mainboard is arranged in the assembly cavity, a button is arranged on the mainboard;
A key is arranged in the assembly cavity and corresponds to the button, the key can move towards the direction close to the button, and one side of the key away from the button is located in the through-hole without protruding out of the through-hole;
And a sleeve, which is fitted onto the housing, and the sleeve is provided with an identification structure corresponding to the position of the through-hole, the sleeve can deform when subjected to pressure.

It can be seen that in the key structure of the invention, the through-hole is arranged on the housing, and the side of the key in the assembly cavity away from the button is located in the through-hole without protruding out of the through-hole. In this way, the sleeve can be placed on the housing, and the identification structure can be set on the sleeve corresponding to the position of the key. This way allows the sleeve to conceal the key, improving the overall integration of the key structure and enhancing the grip sensation. Additionally, setting the identification structure on the sleeve ensures that user can press the key through the sleeve, and then can accurately press the button of the key structure.

As a preferred scheme of the invention, the mainboard is also provided with a luminous part, the luminous part is arranged on one side of the button and corresponds to the key, the key can emit light under the action of the luminous part;

And the identification structure comprises light-transmitting holes arranged on the sleeve, the light-transmitting holes correspond to the key.

As a preferred scheme of the invention, the sleeve is provided with multiple light-transmitting holes, the light-transmitting holes are arranged at intervals on the sleeve, the connecting lines between adjacent light-transmitting holes can form a circular structure on the sleeve, and the circular structure encloses a restricted area.

As a preferred scheme of the invention, the surface of the side of the sleeve away from the housing is provided with a circular groove, multiple light-transmitting holes are respectively arranged in the circular groove to form the circular restricted area.

As a preferred scheme of the invention, it also comprises a bracket, the bracket is arranged in the assembly cavity, the mainboard and key are arranged on the bracket, and the surface of the side of the key close to the sleeve is flush with the surface of the housing;

At least a portion of the bracket, which is connected to the key, can emit light under the action of the luminous part.

As a preferred scheme of the invention, the bracket comprises a first frame and a second frame;

The mainboard is arranged on the first frame and/or the second frame;

The key is arranged on the first frame and corresponds to the button on the mainboard, and the key can move in the direction close to the button relative to the first frame;

The first frame can emit light under the action of the luminous part;

The first frame is arranged in the assembly cavity;

The second frame is inserted into the first frame on the side away from the key along the axial direction of the assembly cavity, and they fit together to make the first frame and second frame tightly clamped in the assembly cavity.

As a preferred scheme of the invention, the first frame is provided with an assembly hole, and the key is arranged in the assembly hole, flanges are arranged on their peripheral sides of the key, and the flanges abut against the side of the first frame away from the sleeve;

The side wall of the first frame is also provided with a squeezing part, the squeezing part is used to press against the side wall of the assembly cavity, so that the first frame can be firmly fixed inside the assembly cavity.

As a preferred scheme of the invention, one end of the housing is provided with a first positioning step, and one end of the sleeve is pressed against the first positioning step;

The other end of the housing is detachably provided with a base, and the base is provided with a second positioning step, and the second positioning step is pressed against on the other end of the sleeve.

An electronic atomizer host comprises a connection structure and a key structure as claimed in any one of claims, the connection structure is arranged at one end of the housing, the connection structure is electrically connected to the mainboard, the connection structure is used for installing the atomizer;

The outer peripheral surface of the connection structure is provided with the first positioning step, and the first positioning step is used for pressing against one end of the sleeve.

As a preferred scheme of the invention, the side of the mainboard away from the key is also connected with a display screen, the housing and the sleeve are provided with a keep-space hole corresponding to the position of the display screen.

### 4. BRIEF DESCRIPTION OF ACCOMPANY DRAWINGS

In order to clarify the technical schemes of the embodiments of the invention more clearly, the accompanying drawings needed to be used in the description of the embodiments or prior art will be briefly introduced below. Obviously, the accompanying drawings in the following description are only some embodiments of the invention. For those of ordinary skill in the art, other accompanying drawings can be obtained based on these accompanying drawings without exerting any creative effort.

FIG. 1 is a schematic diagram of the structure of the electronic atomizer host provided by the invention;

FIG. 2 is a top view of the electronic atomizer host provided by the invention;

FIG. 3 is a cross-sectional view at A-A in FIG. 2;

FIG. 4 is a partial enlarged view of B in FIG. 2;

FIG. 5 is an exploded schematic diagram of the electronic atomizer host provided by the invention.

### ATTACHED DRAWINGS MARKS

100 housing; 110 assembly cavity; 120 through-hole; 130 first positioning step;
200 mainboard; 210 button; 220 luminous part;
300 key; 310 flange;
400 sleeve; 410 identification structure; 411 light-transmitting hole; 412 circular groove; 420 restricted area;
500 bracket; 510 first frame; 520 second frame; 530 assembly hole; 540 squeezing part;
600 base; 610 second positioning step;
700 connection structure; 800 display screen; 900 lens.

### 5. SPECIFIC EMBODIMENT OF THE INVENTION

In order to make the technical problems, technical schemes and advantageous effects to be solved by the invention more clear, the invention will be further described in detail below in combination with the accompanying drawings and embodiments. It should be understood that the specific embodiments described here are only used to explain the invention and are not intended to limit the invention.

It should be noted that when an element is referred to as being “fixed to” or “arranged on” another element, it can be directly on the other element or indirectly on the other element. When an element is referred to as being “connected” to another element, it can be directly connected to the other element or indirectly connected to the other element.

It should be understood that the orientation or positional relationship indicated by the terms “length”, “width”, “upper”, “lower”, “front”, “back”, “left”, “right”, “vertical”, “horizontal”, “top”, “bottom”, “inner”, “outer” and so on are based on the orientation or positional relationship shown in the accompanying drawings, only for the convenience of describing the invention and simplifying the description, rather than indicating or implying that the indicated device or element must have a specific orientation, as well as a specific orientation structure and operation, therefore, it should not be construed as a limitation of the invention.

In addition, the terms of “first”, “second” are only used to describe the object, and should not be construed as indicating or implying relative importance or implicitly indicating the quantity of indicated technical features. Therefore, the features defined as “first”, “second” may explicitly or implicitly include one or more of these features. In the description of the invention, “a plurality of” means two or more, unless otherwise expressly and specifically limited.

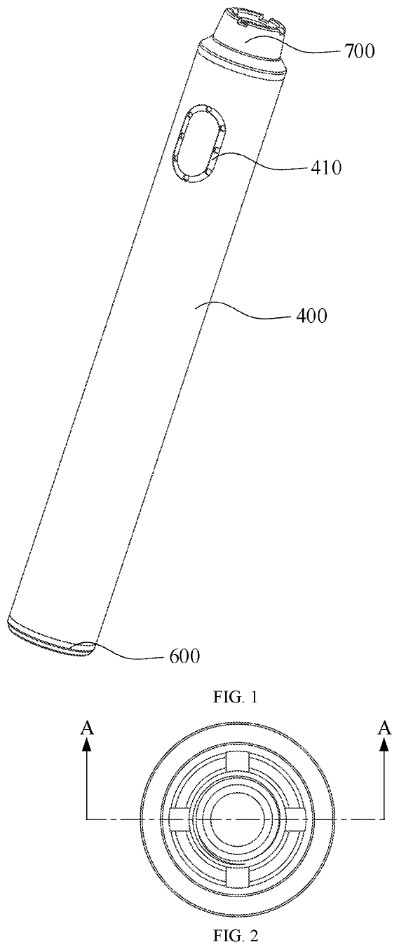

Referring to FIG. 1-FIG. 5, the invention provides a key structure, comprising a housing 100, a mainboard 200, a key 300 and a sleeve 400. Wherein, the housing 100 is provided with an assembly cavity 110, and the housing 100 is provided with a through-hole 120 connected to the assembly cavity 110. The mainboard 200 is arranged in the assembly cavity 110, a button 210 is arranged on the mainboard 200, when the button 210 is pressed, the mainboard 200 can be controlled. The key 300 is arranged in the assembly cavity 110 and corresponds to the button 210, the key 300 can move towards the direction close to the button 210, and one side of the key 300 away from the button 210 is located in the through-hole 120 without protruding out of the through-hole 120. And the sleeve 400 is fitted onto the housing 100, and the sleeve 400 is provided with an identification structure 410 corresponding to the position of the through-hole 120, the sleeve 400 can deform when subjected to pressure.

In some embodiments, the sleeve 400 can be made of leather.

When in use, the identification structure 410 on the sleeve 400 can be pressed, and the pressing force acts on the key 300 through the through-hole 120 of the housing 100, thereby driving the key 300 to move, so that the key 300 can press the button 210 on the mainboard 200.

It can be seen that in the key 300 structure of the invention, the through-hole 120 is arranged on the housing 100, and the side of the key 300 in the assembly cavity 110 away from the button 210 is located in the through-hole 120 without protruding out of the through-hole 120. In this way, the sleeve 400 can be placed on the housing 100, and the identification structure 410 can be set on the sleeve 400 corresponding to the position of the key 300. This way allows the sleeve 400 to conceal the key 300, improving the overall integration of the key 300 and enhancing the grip sensation. Additionally, setting the identification structure 410 on the sleeve 400 ensures that user can press the key 300 through the sleeve 400, and then can accurately press the button 210 of the key 300.

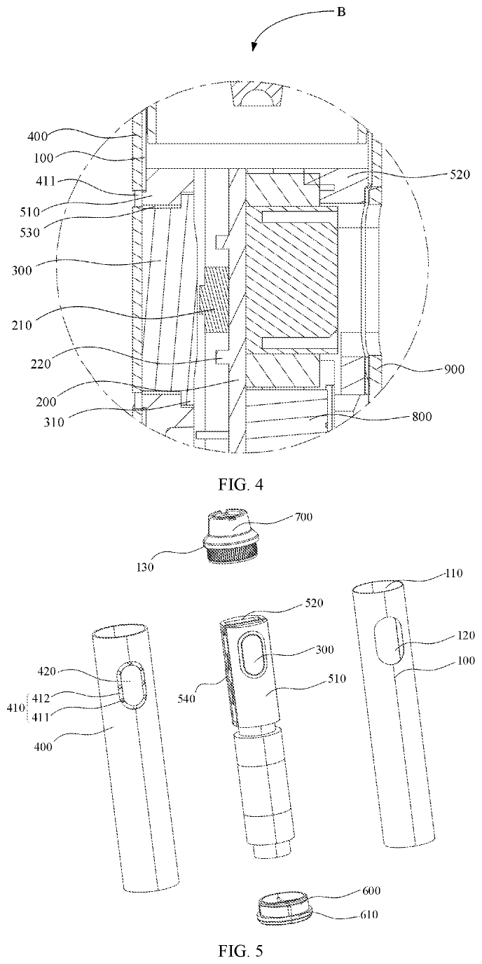

Referring to FIG. 4, the mainboard 200 is also provided with a luminous part 220, the luminous part 220 is arranged on one side of the button 210 and corresponds to the key 300, the key 300 can emit light under the action of the luminous part 220; and the identification structure 410 comprises light-transmitting holes 411 arranged on the sleeve 400, the light-transmitting holes 411 correspond to the key 300.

In some embodiments, the luminous part 220 can be a lamp bead.

The key 300 can emit light under the action of the luminous part 220. At least the part of the key 300 corresponding to the luminous part 220 can be made of light-guiding material; the light-transmitting holes 411 on the sleeve 400 allows the light of the key 300 to be exposed. This enables the user to visually see the light of key 300 through the light-transmitting holes 411 on the sleeve 400. As a result, the user can intuitively determine the location of the corresponding area of the key 300 on the sleeve 400 and can accurately press the key 300 through the sleeve 400.

Further, the sleeve 400 is provided with multiple light-transmitting holes 411, the light-transmitting holes 411 are arranged at intervals, the connecting lines between adjacent light-transmitting holes 411 can form a circular structure on the sleeve 400, and the circular structure encloses a restricted area 420. The restricted area 420 is the pressing area on the sleeve 400. This method can create a structure on the sleeve 400 in disguise, this structure is similar to the key 300, allowing the user to intuitively determine the pressing position of the key 300 on the sleeve 400.

Of course, in some embodiments, in order to ensure that each light-transmitting hole 411 corresponds to the key 300 with distinct or identical brightness, multiple luminous parts 220 can also be arranged on the mainboard 200; these luminous parts 220 can be arranged at intervals, forming a circular structure.

Furthermore, the surface of the side of the sleeve 400 away from the housing 100 is provided with a circular groove 412, multiple light-transmitting holes 411 are respectively arranged in the circular groove 412, and a restricted area 420 is formed around the inside of the circular groove 412. This method allows the user to more intuitively determine the pressing position of the key 300.

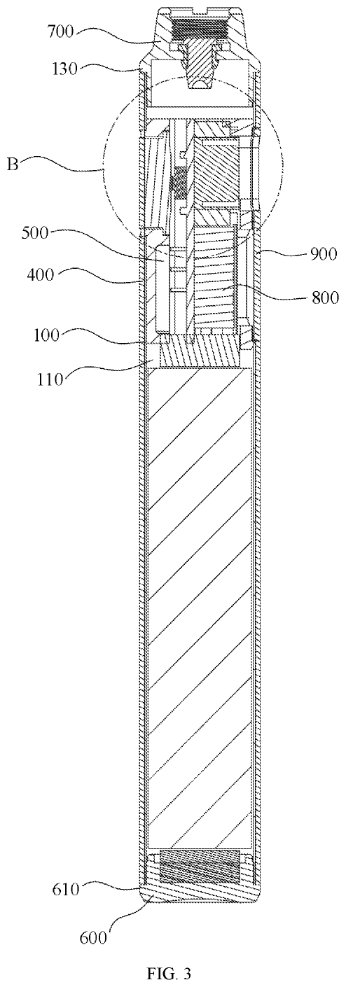

Referring to FIG. 3-FIG. 5, the key 300 also comprises a bracket 500, the bracket 500 is arranged in the assembly cavity 110, the mainboard 200 and key 300 are arranged on the bracket 500, and the surface of the side of the key 300 close to the sleeve 400 is flush with the surface of the housing 100; the bracket 500 facilitates the placement of the mainboard 200 and the key 300 within the assembly cavity 110, while also ensuring that the surface of the side of the key 300 close to the sleeve 400 is flush with the surface of the housing 100. This allows the user to press the key 300 by pressing the pressing area on the sleeve 400, improving the user's pressing experience and feel.

In some embodiments, at least a portion of the bracket 500, which is connected to the key 300, can emit light under the action of the luminous part 220. The bracket 500 can be illuminated in two ways: either by directing the light from the luminous part 220 onto the bracket 500, or by allowing the light from the luminous part 220 to pass through the key 300 and then onto the bracket 500. As a result, the light-transmitting holes 411 on the sleeve 400 can be set corresponding to the bracket 500 that supports the key 300, ensuring that the restricted area 420 can correspond to the entire key 300.

Specifically, in some embodiments, the bracket 500 comprises a first frame 510 and a second frame 520; the mainboard 200 can be arranged on the first frame 510 and/or the second frame 520; for example, the mainboard 200 can be supported by the first frame 510 or the mainboard 200 can be supported by the second frame 520, or the mainboard 200 can be supported by both the first frame 510 and the second frame 520.

The key 300 is arranged on the first frame 510 and corresponds to the button 210 on the mainboard 200, and the key 300 can move in the direction close to the button 210 relative to the first frame 510. The first frame 510 is arranged in the assembly cavity 110; the second frame 520 is inserted into the first frame 510 on the side away from the key 300 along the axial direction of the assembly cavity 110, and they fit together to make the first frame 510 and second frame 520 tightly clamped in the assembly cavity 110.

Understandably, in some embodiments, the side of key 300 away from the button 210 is located within the through-hole 120. Therefore, during assembly, the first frame 510 can be installed into the assembly cavity 110 first, ensuring that the side of the key 300 on the first frame 210 away from the button 210 can be located within the through-hole 120; then, the second frame 520 can be inserted, the first frame 510 and second frame 520 fit together to be clamped in the assembly cavity 110; in this structure, the second frame 520 can function as a latch. This ensures that there is no interference between the key 300 and the housing 100 during the assembly process.

Additionally, in some embodiments, the key 300 can emit light under the action of the luminous part 220, that is, the first frame 510 can be made of light-guiding material; the first frame 510 can be illuminated in two ways: either by directing the light from the luminous part 220 onto the first frame 510, or by allowing the light from the luminous part 220 to pass through the key 300 and then onto the first frame 510. As a result, the light-transmitting holes 411 on the sleeve 400 can be set corresponding to the first frame 510 that supports the key 300, ensuring that the restricted area 420 can correspond to the entire key 300; this structure enables the user to observe the movement of the key 300 through the light-transmitting holes 411, improving the user' use experience.

Referring to FIG. 4, the first frame 510 is provided with an assembly hole 530, and the key 300 is arranged in the assembly hole 530, flanges 310 are arranged on their peripheral sides of the key 300, and the flanges 310 abut against the side of the first frame 510 away from the sleeve 400; this method allows the key 300 to be constrained within the assembly hole 530 by the flanges 310 and the button 210, facilitating the assembly of the key 300. Moreover, this assembly method is simple.

Referring to FIG. 5, in some embodiments, the side wall of the first frame 510 is also provided with a squeezing part 540, the squeezing part 540 is used to press against the side wall of the assembly cavity 110, so that the first frame 510 can be firmly fixed inside the assembly cavity 110, it plays a preliminary role in fixing the first frame 510 in the assembly cavity 110, and facilitates the subsequent insertion of the second frame 520 to fit it with the first frame 510, then they can be clamped firmly in the assembly cavity 110.

Referring to FIG. 3 and FIG. 5, one end of the housing 100 is provided with a first positioning step 130, and one end of the sleeve 400 is pressed against the first positioning step 130 to realize the positioning of the sleeve 400 during assembly.

The other end of the housing 100 is detachably provided with a base 600, and the base 600 is provided with a second positioning step 610, and the second positioning step 610 is pressed against on the other end of the sleeve 400 to fix the sleeve 400 on the outer peripheral surface of the housing 100.

During assembly, the sleeve 400 can be first fitted onto the housing 100, with one end of the sleeve 400 abutting against the first positioning step 130; subsequently, the base 600 can be installed into the end of the housing 100 away from the first positioning step 130, and the second positioning step 610 on the base 600 can abut against the end of the sleeve 400 away from the first positioning step 130, thereby securing the sleeve 400.

The above method facilitates convenient and simple installation of the sleeve 400, and also provides a positioning function for the installation of the sleeve 400.

In addition, referring to FIG. 1-FIG. 5, the invention also provides an electronic atomizer host, comprising a connection structure 700 and a key 300 in the above embodiments, the connection structure 700 is arranged at one end of the housing 100, the connection structure 700 is electrically connected to the mainboard 200, the connection structure 700 is used for installing the atomizer. The connection structure 700 can be a threaded structure, which allows for a threaded connection with the atomizer.

In some embodiments, the first positioning step 130 can be a protruding structure formed by the outer peripheral surface of the connection structure 700.

Further, referring to FIG. 3 and FIG. 4, in some embodiments, the electronic atomizer host also comprises a display screen 800, the display screen 800 is arranged on the side of the mainboard 200 away from the key 300, the housing 100 and the sleeve 400 are provided with a keep-space hole corresponding to the position of the display screen 800, the display screen 800 can be used to display information such as power or status.

Of course, in some embodiments, the keep-space hole on the housing 100 and/or the sleeve 400 can be provided with a lens 900 to provide protection for the display screen 800.

Furthermore, in some embodiments, the electronic atomizer can also comprise a battery, the battery is arranged within the assembly cavity 110 and connected to the mainboard 200 to supply power to the mainboard 200.

The above are only preferred embodiments of the invention and are not intended to limit the invention. Any modifications, equivalent substitutions and improvements made within the spirit and principles of the invention should be included within the protection scope of the invention.

1. A key structure comprises:
A housing with an assembly cavity, and a through-hole connected to the assembly cavity;
A mainboard is arranged in the assembly cavity, a button is arranged on the mainboard;
A key is arranged in the assembly cavity and corresponds to the button, the key can move towards the direction close to the button, and one side of the key away from the button is located in the through-hole without protruding out of the through-hole;
And a sleeve, which is fitted onto the housing, and the sleeve is provided with an identification structure corresponding to the position of the through-hole, the sleeve can deform when subjected to pressure.

2. A key structure of claim 1, the mainboard is also provided with a luminous part, the luminous part is arranged on one side of the button and corresponds to the key, the key can emit light under the action of the luminous part;
And the identification structure comprises light-transmitting holes arranged on the sleeve, the light-transmitting holes correspond to the key.

3. A key structure of claim 2, the sleeve is provided with multiple light-transmitting holes, the light-transmitting holes are arranged at intervals on the sleeve, the connecting lines between adjacent light-transmitting holes can form a circular structure on the sleeve, and the circular structure encloses a restricted area.

4. A key structure of claim 3, the surface of the side of the sleeve away from the housing is provided with a circular groove, multiple light-transmitting holes are respectively arranged in the circular groove to form the circular restricted area.

5. A key structure of claim 4, it also comprises a bracket, the bracket is arranged in the assembly cavity, the mainboard and key are arranged on the bracket, and the surface of the side of the key close to the sleeve is flush with the surface of the housing;
At least a portion of the bracket, which is connected to the key, can emit light under the action of the luminous part.

6. A key structure of claim 5, the bracket comprises a first frame and a second frame;
The mainboard is arranged on the first frame and/or the second frame;
The key is arranged on the first frame and corresponds to the button on the mainboard, and the key can move in the direction close to the button relative to the first frame;
The first frame can emit light under the action of the luminous part;
The first frame is arranged in the assembly cavity;
The second frame is inserted into the first frame on the side away from the key along the axial direction of the assembly cavity, and they fit together to make the first frame and second frame tightly clamped in the assembly cavity.

7. A key structure of claim 6, the first frame is provided with an assembly hole, and the key is arranged in the assembly hole, flanges are arranged on their peripheral sides of the key, and the flanges abut against the side of the first frame away from the sleeve;
The side wall of the first frame is also provided with a squeezing part, the squeezing part is used to press against the side wall of the assembly cavity, so that the first frame can be firmly fixed inside the assembly cavity.

8. A key structure of claim 1, one end of the housing is provided with a first positioning step, and one end of the sleeve is pressed against the first positioning step;
The other end of the housing is detachably provided with a base, and the base is provided with a second positioning step, and the second positioning step is pressed against on the other end of the sleeve.

9. An electronic atomizer host comprises a connection structure and a key structure as claimed in claim 1, the connection structure is arranged at one end of the housing, the connection structure is electrically connected to the mainboard, the connection structure is used for installing the atomizer;
The outer peripheral surface of the connection structure is provided with the first positioning step, and the first positioning step is used for pressing against one end of the sleeve.

10. An electronic atomizer host of claim 1, the side of the mainboard away from the key is also connected with a display screen, the housing and the sleeve are provided with a keep-space hole corresponding to the position of the display screen.
